(19) United States
(12) Patent Application Publication
(10) Pub. No.: US 2007/0137704 A1
(43) Pub. Date: Jun. 21, 2007

(54) Thermal trip stop valve

(75) Inventor: Michael Dean Hartley, Beatrice, NE (US)

Correspondence Address: WOOD, PHILLIPS, KATZ, CLARK & MORTIMER;Citigroup Center, Suite 3800, 500 West Madison Street, Chicago, IL, 60661-2511, US

(73) Assignee: Hoover Materials Handling Group

(21) Appl. No.: 11/332,580

(22) Filed: Jan. 13, 2006

Related U.S. Application Data
(60) Provisional application No. 60/751,370, filed on Dec. 16, 2005.

(51) Int. Cl. F16K 17/40

(52) U.S. Cl. 137/75

(57) ABSTRACT

An intermediate bulk container (IBC) for offloading materials comprises a portable tank including a bottom wall having a bottom discharge outlet. A thermal trip stop valve is mounted at the discharge outlet. The thermal trip stop valve comprises a spring loaded emergency valve biased to a closed position and including a lever arm actuable to operate the valve to an open position. A fusible link operatively connects a pull handle to the lever arm so the pull handle manually operates the emergency valve. A latch mechanism latches the pull handle with the emergency valve in the open position, whereby the fusible link opens under high temperature conditions to disconnect the pull handle from the lever arm to close the emergency valve.

### CROSS REFERENCE TO RELATED APPLICATIONS

This application claims priority of Provisional application No. 60/751,370 filed Dec. 16, 2005.

### FIELD OF THE INVENTION

The present invention relates to a thermal trip stop valve and, more particularly, to a thermal trip stop valve used with an intermediate bulk container.

### BACKGROUND OF THE INVENTION

Bulk packaging containers have found widespread use for storage and shipment of bulk goods. The bulk packaging containers assume many different forms. Among these forms are portable tanks and intermediate bulk containers (IBC). Requirements for these types of containers are outlined in various D. O. T. and F. D. A. regulations and are particularly defined in 49CFR Section 171.8.

Among IBCs, there include numerous types of designs. These include metal IBCs, which are constructed of metal, rigid plastic IBCs which are constructed of all-plastic material, and composite IBCs which include a rigid outer package enclosing a plastic inner receptacle.

An IBC typically has a capacity in the range of 250-550 gallons. Some are as large as 793 gallons. As such, they are an efficient alternative to 55-gallon drums. Nevertheless, each IBC must be handled and transported individually when used, for example, in the export of materials. The IBC is typically loaded into a shipping vessel. Each IBC must be individually slung by a crane or carried by a forklift during the loading and unloading.

Recently, regulations have been implemented for authorizing the offloading of hazardous materials from IBCs that remain aboard a motor vehicle. DOT-E 12412 section 178.275(d)(3) generally requires that every bottom discharge outlet must be equipped with three serially fitted and mutually independent shut-off devices. The design of the equipment must include: (i) A self-closing internal stop-valve, which is a stop-valve within the shell or within a welded flange or its companion flange, such that: (A) The control devices for the operation of the valve are designed to prevent any unintended opening through impact or other inadvertent act; (B) The valve is operable from above or below; (C) If possible, the setting of the valve (open or closed) must be capable of being verified from the ground; (D) Except for portable tanks having a capacity less than 1,000 liters (264.2 gallons), it must be possible to close the valve from an accessible position on the portable tank that is remote from the valve itself within 30 seconds of actuation; and (E) The valve must continue to be effective in the event of damage to the external device for controlling the operation of the valve; (ii) An external stop-valve fitted as close to the shell as reasonably practicable; (iii) A liquid tight closure at the end of the discharge pipe, which may be a bolted blank flange or a screw cap; and (iv) For UN portable tanks, with bottom outlets, used for the transportation of liquid hazardous materials that are Class 3, PG I or II, or PG III with a flash point of less than 100° F. (38° C.); Division 5.1, PG I or II; or Division 6.1, PG I or II, the remote means of closure must be capable of thermal activation. The thermal means of activation must activate at a temperature of not more than 250° F. (121° C.).

The present invention is directed to satisfying the above requirements.

### SUMMARY OF THE INVENTION

In one aspect, the present invention is directed to a thermal trip stop valve. The thermal trip stop valve may comprise a spring loaded emergency valve biased to a closed position and including a lever arm actuable to operate the valve to an open position. A fusible link operatively connects a pull handle to the lever arm so the pull handle manually operates the emergency valve. A latch mechanism latches the pull handle with the emergency valve in the open position, whereby the fusible link opens under high temperature conditions to disconnect the pull handle from the lever arm to close the emergency valve.

In another aspect, the invention is directed to an apparatus comprising a bottom wall with a discharge outlet closed by a thermal trip stop valve. The thermal trip stop valve mounted at the discharge outlet including a spring loaded emergency valve, the emergency valve biased to a closed position and including a lever arm actuable to operate the valve to an open position, a pull handle, a fusible link operatively connecting the pull handle to the lever arm so the pull handle manually operates the emergency valve; and a latch mechanism for latching the pull handle with the emergency valve in the open position, whereby the fusible link opens under high temperature conditions to disconnect the pull handle from the lever arm to close the emergency valve.

In accordance with another aspect, the present invention comprises an intermediate bulk container (IBC) for offloading materials comprising a portable tank including a bottom wall having a bottom discharge outlet. A thermal trip stop valve is mounted to the portable tank discharge outlet.

Further features and advantages of the invention will be apparent from the specification and the drawings.

### BRIEF DESCRIPTION OF THE DRAWINGS

FIG. 1 is a top plan view of an intermediate bulk container (IBC) including a thermal trip stop valve in accordance with the invention;

FIG. 2 is a front elevation view of the IBC of FIG. 1;

FIG. 3 is a side elevation view of the IBC of FIG. 1;

FIG. 4 is a partial side elevation view of the thermal trip stop valve in accordance with the invention mounted to a bottom wall;

FIG. 5 is a front elevation view of the thermal trip stop valve of FIG. 4 with parts removed for clarity;

FIG. 6 is a side elevation view of the thermal trip stop valve in accordance with the invention shown in a closed position;

FIG. 7 is a side elevation view of the thermal trip stop valve in accordance with the invention shown in an open position; and

FIG. 8 is a side elevation view of the thermal trip stop valve in accordance with the invention shown in a thermal trip position.

### DETAILED DESCRIPTION OF THE INVENTION

The present invention relates generally to a thermal trip stop valve used, for example, on the bottom wall of a portable tank, such as an intermediate bulk container (IBC) for transporting and storing materials, such as liquid materials. Particularly, the thermal trip stop valve used on an IBC, with other appurtenances, satisfies requirements for offloading hazardous materials from IBCs that remain aboard a motor vehicle.

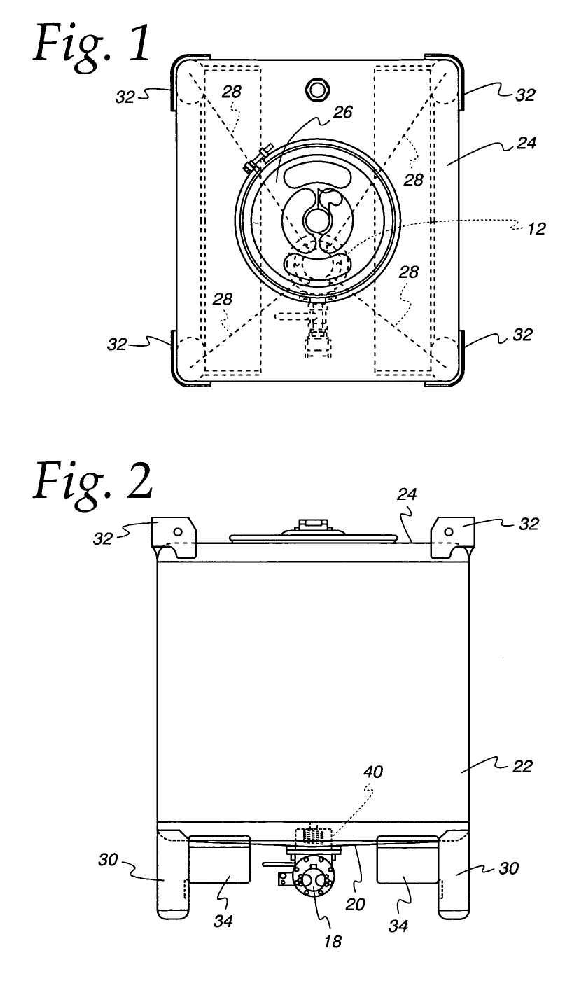

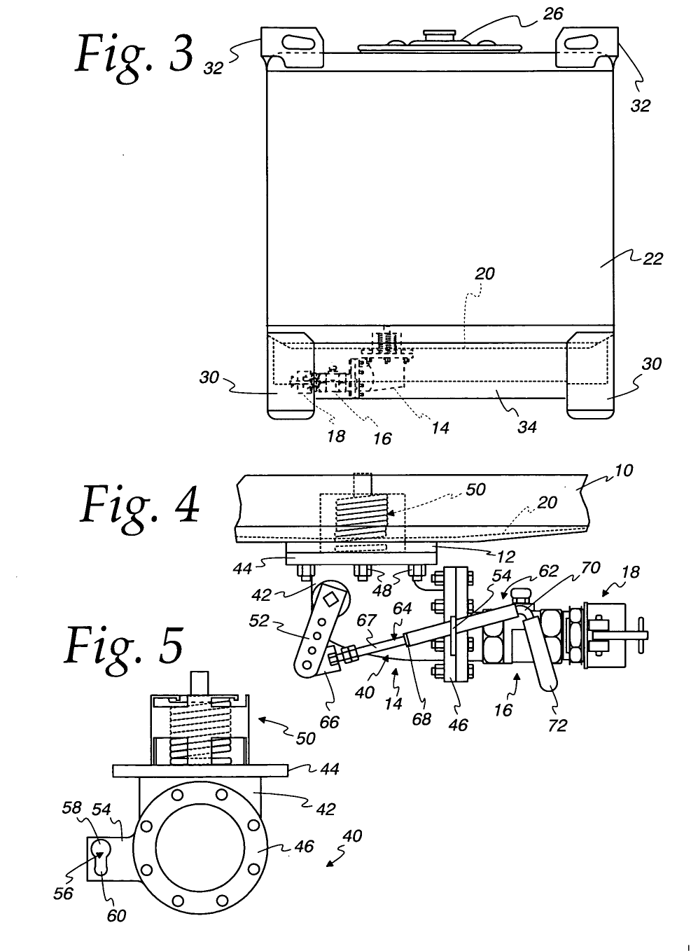

Referring to FIGS. 1-3, a portable tank 10, in the form of an IBC, includes a bottom discharge outlet 12, see FIG. 4, equipped with three serially fitted and mutually independent shut-off devices, namely, a self closing, internal, thermal trip stop valve 14, an external stop, ball valve 16, and a liquid tight closure 18, such as a dust cap. The ball valve 16 is of conventional construction and includes a quick connect adapter for connecting to the dust cap 18 or an external hose (not shown).

The IBC 10 comprises a bottom wall 20, surrounded by a peripheral side wall 22 closed by a top wall 24. The top wall 24 includes a fill opening (not shown) closed by a cover 26. The bottom wall 20 includes creases, shown by dashed lines 28, so that the bottom wall 20 slopes toward the discharge outlet 12. Four formed legs 30 are provided at each corner of the bottom wall 20 to support the IBC 10 on a support surface or for stacking on another IBC. Lifting lugs 32 are provided at each corner of the top wall 24. Formed, two-way fork channels 34 extend longitudinally under the bottom wall 20 for transporting using a fork lift device.

In the illustrated embodiment of the invention, the thermal trip stop valve 14 is shown on an IBC 10 manufactured and sold by the assignee of the present invention under the trademark LIQUITOTE®. The LIQUITOTE® IBC is a steel container typically providing capacity in the range of 255 to 550 gallons, although some are as large as 793 gallons, and has a nominal width of 42 inches and nominal length of either 42 or 48 inches. The capacity is otherwise determined by height of the container, which is variable. Although the thermal trip valve 14 is illustrated on the LIQUITOTE® IBC, the thermal trip valve could be used with other types of IBCs, portable tanks, or the like, as will be apparent skilled in the art. Such containers may provide capacity in the range of 120 to 793 gallons. Also, the IBC could be manufactured of rigid plastic or be of composite construction, as is known. As used herein, the term intermediate bulk container is intended to also refer more generally to portable tanks, as is known in the art.

The thermal trip valve, see FIG. 4, comprises a spring loaded emergency valve 40. The emergency valve 40 may be, for example, a three inch stainless steel, cable operated emergency valve such as provided by Betts Industries. As will be apparent, other emergency valves could also be used in connection with the present invention. The valve 40 comprises a body 42 extending between an inlet flange 44 and an outlet flange 46. The inlet flange 44 is secured at the discharge outlet 12 using connectors 48. A spring actuated valve structure, illustrated generally at 50, extends into the IBC 10. A lever arm 52 is operatively connected to the spring actuated valve structure 50 for controlling valve open and close position. The valve 40 is shown in the valve close position in FIG. 4. The valve outlet flange 46 is adapted to include a plate 54 extending sidewardly therefrom, see FIG. 5. The plate 54 has a keyhole slot opening 56 having an enlarged top 58 and narrowed bottom 60.

The thermal trip valve 14 includes an operator 62 comprising a pull handle 64 linked to the lever arm 52 with a fusible link 66. The handle 62 includes a rod 67 having a diameter less than the size of the keyhole slot opening narrowed bottom 60. An annular ring 68 is welded to the rod 67 spaced from the fusible link 66. The ring 68 has a diameter greater than the keyhole slot opening narrowed bottom 60 but less than the enlarged top 58. The rod 67 is turned at 70 to define a gripping portion 72. A sleeve 74 is telescopically received on the rod 67 between the ring 68 and the turned portion 70. The gripping portion 72 enables a user to open or close the thermal trip stop valve 14 without directly actuating the lever arm 52.

The pull handle 62 extends through the keyhole slot opening 58. The fusible link 66 connects the handle to the lever arm 52, as shown, but in case of a fire will burn off at a select temperature and disconnect the handle 62 from the valve arm 52 to automatically close the valve 40. The fusible link 66 may be, for example, of the type provided by Betts Industries and provides thermal activation at not more than 250° F.

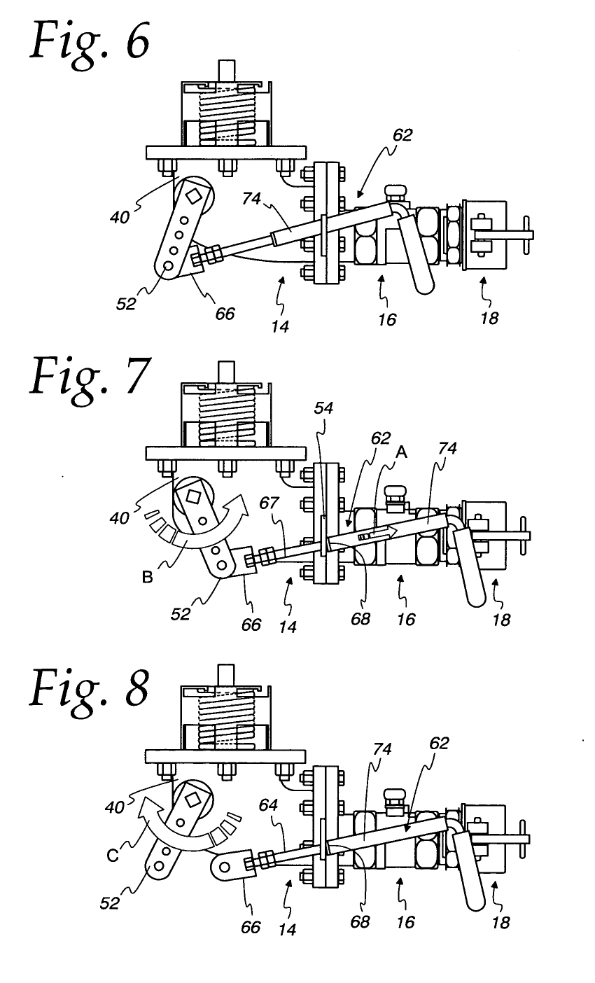

FIG. 6 illustrates the thermal trip stop valve 14 with the operator 62 in the close position linked via the fusible link 66 to the lever arm 52 so the emergency valve 40 is in the close position. In this position, the sleeve 74 extends through the keyhole slot opening enlarged top 58.

The thermal trip stop valve 14 is opened by pulling the handle 64, as shown by the arrow A in FIG. 7, which turns the lever arm 52, as shown by the arrow B, to move the emergency valve 40 to the open position against the spring force. The operator 62 is latched by lowering the rod 67 so that it is received in the keyhole slot narrowed portion 60 with the ring 68 engaging the plate 54.

Under extreme high temperature conditions, such as with a fire, the fusible link 66 will melt and separate the pull handle 64 from the valve arm 52, see FIG. 8. The spring force of the emergency valve 40 will close the valve moving the lever arm 52 to the close position, as shown by the arrow C. This is the trip position with the emergency valve 40 closed and the operator 62 in the latched position also shown in FIG. 7. Thereafter, the fusible link 66 must be replaced to operate the thermal trip stop valve 14.

Thus, in accordance with the invention, there is provided an intermediate bulk container comprising a bottom wall having a bottom outlet and a spring loaded emergency valve with a pull handle which is attached to the emergency valve via a fusible link, the valve being mounted to the bottom wall at the outlet. The position of the valve is visible from the ground, as is apparent in the views of FIGS. 6-8.

I claim:

1. A thermal trip stop valve comprising:
a spring loaded emergency valve biased to a closed position and including a lever arm actuable to operate the valve to an open position;
a pull handle;
a fusible link operatively connecting the pull handle to the lever arm so the pull handle manually operates the emergency valve; and
a latch mechanism for latching the pull handle with the emergency valve in the open position, whereby the fusible link opens under high temperature conditions to disconnect the pull handle from the lever arm to close the emergency valve.

2. The thermal trip stop valve of claim 1 wherein the latch mechanism comprises a plate on the emergency valve having a slot opening and the pull handle comprises a rod extending through the slot opening and having a projection for selectively engaging the plate.

3. The thermal trip stop valve of claim 2 wherein the slot opening comprises a keyhole slot opening.

4. The thermal trip stop valve of claim 1 wherein the emergency valve comprises a flange having an extension plate with a keyhole slot and the latch mechanism comprises an arcuate ring on the pull handle for selectively engaging the plate.

5. The thermal trip stop valve of claim 1 wherein the fusible link opens at a temperature of about 250° F.

6. An apparatus comprising a bottom wall having a discharge outlet, and a thermal trip stop valve mounted at the discharge outlet including a spring loaded emergency valve, the emergency valve biased to a closed position and including a lever arm actuable to operate the valve to an open position, a pull handle, a fusible link operatively connecting the pull handle to the lever arm so the pull handle manually operates the emergency valve; and a latch mechanism for latching the pull handle with the emergency valve in the open position, whereby the fusible link opens under high temperature conditions to disconnect the pull handle from the lever arm to close the emergency valve.

7. The apparatus of claim 6 wherein the latch mechanism comprises a plate on the emergency valve having a slot opening and the pull handle comprises a rod extending through the slot opening and having a projection for selectively engaging the plate.

8. The apparatus of claim 7 wherein the slot opening comprises a keyhole slot opening.

9. The apparatus of claim 6 wherein the emergency valve comprises a flange having an extension plate with a keyhole slot and the latch mechanism comprises an arcuate ring on the pull handle for selectively engaging the plate.

10. The apparatus of claim 6 wherein the fusible link opens at a temperature of about 250° F.

11. The apparatus of claim 6 further comprising a ball valve connected to the emergency valve.

12. An intermediate bulk container (IBC) for offloading materials comprising:
a portable tank including a bottom wall having a bottom discharge outlet; and
a thermal trip stop valve mounted to the portable tank discharge outlet including
a spring loaded emergency valve biased to a closed position and including a lever arm actuable to operate the valve to an open position;
a pull handle;
a fusible link operatively connecting the pull handle to the lever arm so the pull handle manually operates the emergency valve; and
a latch mechanism for latching the pull handle with the emergency valve in the open position, whereby the fusible link opens under high temperature conditions to disconnect the pull handle from the lever arm to close the emergency valve.

13. The IBC of claim 12 wherein the latch mechanism comprises a plate on the emergency valve having a slot opening and the pull handle comprises a rod extending through the slot opening and having a projection for selectively engaging the plate.

14. The IBC of claim 13 wherein the slot opening comprises a keyhole slot opening.

15. The IBC of claim 12 wherein the emergency valve comprises a flange having an extension plate with a keyhole slot and the latch mechanism comprises an arcuate ring on the pull handle for selectively engaging the plate.

16. The IBC of claim 12 wherein the fusible link opens at a temperature of about 250° F.

17. The IBC of claim 12 further comprising a ball valve connected to the emergency valve.

18. The IBC of claim 12 wherein the bottom wall is sloped toward the discharge outlet.

19. The IBC of claim 12 wherein the portable tank comprises a steel tank.

20. The IBC of claim 12 wherein the portable tank comprises a tank having a capacity in the range of about 120 to 793 gallons.
